(19) United States
(12) Patent Application Publication
(10) Pub. No.: US 2018/0208831 A1
(43) Pub. Date: Jul. 26, 2018

(54) ENCAPSULATED AGENT AND VARIABLE VISCOSITY FLUID

(71) Applicant: ADEKA CORPORATION, Tokyo (JP)

(72) Inventors: Masatoshi HOMMA, Tokyo (JP); Kazuyuki NODA, Tokyo (JP); Hirokatsu SHINANO, Tokyo (JP); Yoshihiro ISHIKAWA, Tokyo (JP); Daisuke SAWAMOTO, Tokyo (JP); Kensaku AKIMOTO, Tokyo (JP)

(73) Assignee: ADEKA CORPORATION, Tokyo (JP)

(21) Appl. No.: 15/745,508

(22) PCT Filed: Jul. 29, 2016
(86) PCT No.: PCT/JP2016/072381

§ 371 Date: Jan. 17, 2018

(30) Foreign Application Priority Data
Jul. 31, 2015 (JP) 2015-152589

(51) Int. Cl. C09K 8/70; E21B 43/267; C09K 8/68

(52) U.S. Cl. CPC C09K 8/706; C09K 2208/26; C09K 8/68; E21B 43/267

(57) ABSTRACT

An encapsulated agent includes: a central part 1; and an outer part 2 that covers a surface of the central part 1. The central part 1 contains a viscosity-reducing material that reduces the viscosity of a fluid to be used in a hydrofracturing technique. The outer part 2 enables gradual release of the central part 1 in the fluid, and contains a styrene-butadiene copolymer having glass-transition temperature that is equal to or higher than −20 degrees centigrade and equal to or lower than 80 degrees centigrade.

### TECHNICAL FIELD

The invention relates to an encapsulated agent that reduces viscosity of a fluid, and to a variable viscosity fluid that uses the encapsulated agent.

### BACKGROUND ART

In association with concerns about supply of energy, shale gas has attracted attention as new energy (for example, see NPTL 1). The shale gas is natural gas contained in a shale stratum. However, the shale gas is so-called unconventional natural gas, which makes it difficult to collect the shale gas from the earth.

Accordingly, as a method of collecting the shale gas from the earth, a hydrofracturing technique has drawn attention (for example, see NPTL 2). The hydrofracturing technique is a method of artificially fracturing a reservoir rock in the vicinity of a well by applying pressure to a fracturing fluid with which the inside of the well is filled. At the time of fracturing of the reservoir rock, cracks (fractures) occur, which allows the shale gas to be collected through the cracks.

The fracturing fluid contains a plurality of particulate substances (proppants) to prevent the cracks from getting blocked after fracturing of the reservoir rock. The plurality of particulate substances are particles of sand, etc.

In the event of occurrence of the cracks, the fracturing fluid applied with pressure comes into the cracks, and accordingly the plurality of particulate substances contained in the fracturing fluid also come into the cracks. As a result, the cracks are retained as they are even if the application of pressure to the fracturing fluid is stopped.

Further, the fracturing fluid contains a viscosity-reducing agent to collect the fracturing fluid after fracturing of the reservoir rock.

To ensure that the plurality of particulate substances easily come into the cracks, the viscosity of the fracturing fluid is desirably high prior to fracturing of the reservoir rock. Meanwhile, after the plurality of particulate substances come into the cracks, to facilitate collection of the fracturing fluid with which the inside of the well is filled, the viscosity of the fracturing fluid is desirably low after the fracturing of the reservoir rock. Therefore, the viscosity-reducing agent (a breaker) having a function of reducing the viscosity of the fracturing fluid (a viscosity-reducing function) is in use.

Concerning a configuration of the viscosity-reducing agent, specific proposals have been already made. For example, to exercise the viscosity-reducing function in the middle of the use of the fracturing fluid, a viscosity-reducing agent (an encapsulated agent) having a capsule structure is in use (for example, see PTL 1). In such an encapsulated agent, a material having the viscosity-reducing function is covered with a coating film that is decomposed utilizing a hydrolysis reaction. The coating film includes poly (2-alkyl cyanoacrylate), etc. as a material to be decomposed utilizing the hydrolysis reaction.

### CITATION LIST

### Non-Patent Literature

NPTL 1: Ken Ihara, “The Impact of the Shale Gas”, Analysis, 2010.5, Vol. 44, No. 3, pp. 15-38, Internet URL: http://oilgas-info.jogmec.go.jp/pdf/3/3574/201005#015a.pdf
NPTL 2: Ken Ihara, “The History and Impact of the Hydrofracturing Technique”, Analysis, 2011.5, Vol. 45, No. 3, pp. 17-30, Internet URL: http://oilgas-info.jogmec.go.jp/pdf/4/4370/201105#017a.pdf

### Patent Literature

PTL 1: International Publication No. WO 99/061747

### SUMMARY OF THE INVENTION

Use of an encapsulated agent as a viscosity-reducing agent without limiting an application thereof to a hydrofracturing technique is extremely advantageous in controlling viscosity of a fluid. However, in a case where the encapsulated agent is used, it is desired to sufficiently reduce the viscosity of the fluid in a short amount of time at intended timing, and therefore, there is still room for improvement concerning a viscosity-reducing function of the encapsulated agent.

It is therefore desirable to provide an encapsulated agent and a variable viscosity fluid that are able to exercise a superior viscosity-reducing function.

As a result of considerations with a concentrated mind to accomplish the above-described objective, the inventors have found that, in an encapsulated agent that includes a central part containing a viscosity-reducing material and an outer part, the above-described problem is solved by causing the outer part to contain a specific polymer compound.

The invention is achieved on the basis of the above-described findings. An encapsulated agent according to one embodiment of the invention includes: a central part containing a viscosity-reducing material that reduces viscosity of a fluid to be used in a hydrofracturing technique; and an outer part. The outer part (1) covers a surface of the central part, (2) enables gradual release of the central part in the fluid, and (3) contains a styrene-butadiene copolymer having glass-transition temperature that is equal to or higher than −20 degrees centigrade and equal to or lower than 80 degrees centigrade.

A variable viscosity fluid according to one embodiment of the invention includes a fluid body; and one or not less than two encapsulated agents. The one or not less than two encapsulated agents include: a central part containing a viscosity-reducing material that reduces viscosity; and an outer part. The outer part (1) covers a surface of the central part, (2) enables gradual release of the central part in the fluid, and (3) contains a styrene-butadiene copolymer having glass-transition temperature that is equal to or higher than −20 degrees centigrade and equal to or lower than 80 degrees centigrade.

Here, the “encapsulated agent” is used in a state of being contained in the fluid (or the variable viscosity fluid). Accordingly, the “viscosity-reducing material” that is contained in the central part means a material having a function of reducing the viscosity of the fluid containing the encapsulated agent. Further, to “enable gradual release of the central part in a fluid” means that it is possible to gradually release the central part (the viscosity-reducing material) into the fluid utilizing some kind of phenomenon in the fluid. The reason for the gradual release of the central part that is performed by the outer part is to exercise the above-described function of the viscosity-reducing material by exposing the central part after the elapse of a certain period of time after the start of use of the encapsulated agent, not from a starting time point of use of the encapsulated agent. It is to be noted that the kind of phenomenon to be utilized for the gradual release of the central part that is performed by the outer part is not limited specifically. For example, one kind or not less than two kinds of phenomena are utilizable including any of thermal expansion, melting, cracking, deformation, cleavage, swelling, dissolution, and dispersion into the fluid, etc. that are caused by heat, friction, pressure, and contact with the fluid, etc.

The kind of the “styrene-butadiene copolymer” is not specifically limited as long as it has the glass-transition temperature within the above-described range. In other words, the number of kinds of the styrene-butadiene copolymer may be one or not less than two. Further, the styrene-butadiene copolymer may not be modified, or may be modified by functional groups of one kind or not less than two kinds.

According to the encapsulated agent of the embodiment of the invention, the surface of the central part containing the viscosity-reducing material is covered with the outer part containing the styrene-butadiene copolymer that satisfies the above-described condition concerning the glass-transition temperature. This allows the superior viscosity-reducing function to be exercised.

According to the variable viscosity fluid of the embodiment of the invention, the one or not less than two encapsulated agents are included. In such an encapsulated agent, the surface of the central part containing the viscosity-reducing material is covered with the outer part containing the styrene-butadiene copolymer that satisfies the above-described condition concerning the glass-transition temperature. This allows the superior viscosity-reducing function to be exercised, which makes it possible to obtain a superior viscosity variation property.

### BRIEF DESCRIPTION OF DRAWINGS

FIG. 1 is a cross-sectional view of a configuration of an encapsulated agent according to an embodiment of the invention.

FIG. 2 is a cross-sectional view of another configuration of the encapsulated agent according to the embodiment of the invention.

FIG. 3 is a diagram illustrating a configuration of a variable viscosity fluid according to an embodiment of the invention.

FIG. 4 is a diagram illustrating another configuration of the variable viscosity fluid according to the embodiment of the invention.

### MODES FOR CARRYING OUT THE INVENTION

Hereinafter, embodiments of the invention are described in detail. The order of descriptions is as follows. However, the details concerning the invention are not limited to the embodiments described below, and may be modified as appropriate.

### 1. Encapsulated Agent

1-1. Configuration

1-2. Function

1-3. Manufacturing Method

1-4. Workings and Effects

### 2. Application of Encapsulated Agent (Variable Viscosity Fluid)

2-1. Configuration

2-2. Function

2-3. Workings and Effects

### [1. Encapsulated Agent]

A description is provided of an encapsulated agent according to an embodiment of the invention.

The encapsulated agent described here is a viscosity-reducing agent that exercises a viscosity-reducing function in the middle of use of a fluid, that is a function of reducing the viscosity of the fluid, through the use in a state of being contained in the fluid. The encapsulated agent is dispersed in the fluid, for example.

The application of the encapsulated agent is not specifically limited as long as the application necessitates reduction in the viscosity of the fluid in the middle of use thereof for some reason or other. The application of the encapsulated agent is mainly determined by the intended use of the above-described fluid.

Specifically, the encapsulated agent is used in a hydrofracturing technique, for example. A fluid to be used in the hydrofracturing technique is a so-called fracturing fluid.

### [1-1. Configuration]

First, a description is provided of a configuration of the encapsulated agent.

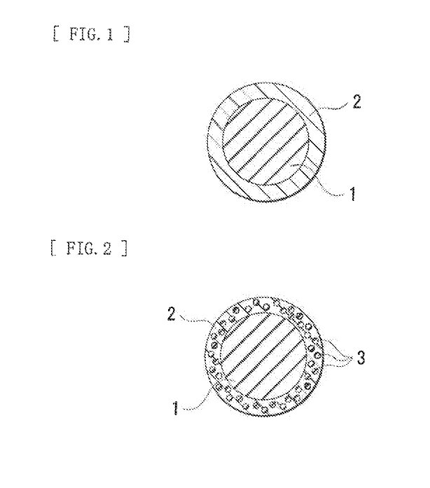

FIG. 1 illustrates a cross-sectional configuration of the encapsulated agent according to an embodiment of the invention. The encapsulated agent includes a central part 1 and an outer part 2. In other words, the encapsulated agent has a structure (a capsule structure) in which a main body (the central part 1) that exercises the viscosity-reducing function substantially is provided inside a hollow structure (the outer part 2).

A shape of the encapsulated agent is not specifically limited, and the encapsulated agent takes a spherical shape, a plate-like shape, a massive shape, etc., for example. FIG. 1 illustrates a case where the encapsulated agent takes the spherical shape, for example.

Dimensions of the encapsulated agent are not specifically limited. For example, in a case where the encapsulated agent takes the spherical shape, an average particle size (a volume average particle size) of the encapsulated agent is within the range of about 100 μm to about 2000 μm.

### [Central Part]

The central part 1 is a so-called core of the encapsulated agent, and contains one kind or not less than two kinds of any of viscosity-reducing materials.

As described above, the “viscosity-reducing material” is a material having the viscosity-reducing function, and more specifically, is a material that is able to exercise a function of reducing the viscosity of a fluid containing the encapsulated agent. At the time of use of the encapsulated agent, as described later, the outer part 2 performs gradual release of the central part 1, and the central part 1 (the viscosity-reducing material) is thereby released into the fluid. As a result, the viscosity-reducing material exercises the viscosity-reducing function.

The principle (technical basis) on which the viscosity-reducing material reduces the viscosity of the fluid is not specifically limited. In other words, the viscosity-reducing material may be a material that chemically reduces the viscosity of the fluid (a chemical viscosity-reducing material), may be a material that non-chemically reduces the viscosity of the fluid (a non-chemical viscosity-reducing material), or may be both of such materials.

“To chemically reduce the viscosity of the fluid” means that the viscosity-reducing material exercises the viscosity-reducing function utilizing some kind of chemical reaction between the viscosity-reducing material and the fluid. The “chemical reaction” includes one kind or not less than two kinds of a reaction leading to formation of a chemically-new substance, a reaction leading to chemical decomposition of an existing substance, etc.

It is to be noted that a substance that reacts with the chemical viscosity-reducing material is not specifically limited as long as it includes one kind or not less than two kinds of any components contained in the fluid. The details of the chemical viscosity-reducing material are described later.

Meanwhile, “to non-chemically reduce the viscosity of the fluid” means that the viscosity-reducing material exercises the viscosity-reducing function without utilizing the above-described chemical reaction. Examples of the non-chemical viscosity-reducing material include one kind or not less than two kinds of any of a solvent for dilution, etc.

In a case where the fluid is a liquid, and the viscosity-reducing material is the solvent for dilution, the fluid and the solvent are mixed and the fluid is thereby diluted by the solvent. This decreases the concentration of a solid content in the fluid, resulting in reduction in the viscosity of the fluid. In such a case, the viscosity of the fluid is reduced without utilizing the chemical reaction, and therefore the solvent for dilution is an example of the non-chemical viscosity-reducing material.

In particular, the viscosity-reducing material is preferably the chemical viscosity-reducing material. This is because the chemical viscosity-reducing material is significantly more efficient in reducing the viscosity of the fluid in comparison with the non-chemical viscosity-reducing material. This allows the viscosity of the fluid to be sufficiently reduced in a short amount of time.

Accordingly, in a case where the fluid in the form of a liquid contains a viscosity-thickening agent, the viscosity-reducing material is preferably one kind or not less than two kinds of materials that decompose the viscosity-thickening agent. This is because, in the fluid containing the viscosity-thickening agent, the viscosity of the fluid is increased with use of a function of the viscosity-thickening agent, and therefore the viscosity of the fluid is reduced utilizing the chemical reaction (a decomposition reaction of the viscosity-thickening agent) owing to decomposition of part or all of the viscosity-thickening agent by the viscosity-reducing material.

Here, the chemical viscosity-reducing material is described in detail. A series of the chemical viscosity-reducing materials described here corresponds to the above-described materials that decompose the viscosity-thickening agent.

Specific examples of the chemical viscosity-reducing material include a metal salt, a metal oxide, a non-metal oxide, an inorganic oxide, an inorganic acid, an inorganic acid salt, an organic peroxide, an organic acid, a metal halide, a metal sulfide, an enzyme, an onium salt, etc.

It is to be noted that a kind of metal elements contained as constituent elements in the above-described specific examples (the metal salt, etc.) of the chemical viscosity-reducing material is not specifically limited as long as such metal elements are one kind or not less than two kinds of any of metal elements.

In particular, the metal element is preferably any of an alkali metal element and an alkali-earth metal element. This is because the chemical viscosity-reducing material is available easily and steadily, and it is easy for the available chemical viscosity-reducing material to reduce the viscosity of a fluid.

A kind of the alkali metal element is not specifically limited, and examples thereof include lithium (Li), sodium (Na), potassium (K), rubidium (Rb), cesium (Cs), etc. A kind of the alkali-earth metal element is not specifically limited, and examples thereof include beryllium (Be), magnesium (Mg), calcium (Ca), strontium (Sr), barium (Ba), etc.

Further, a kind of onium ion contained as a constituent element in the above-described specific examples (the onium salt) of the chemical viscosity-reducing material is not specifically limited as long as it includes one kind or not less than two kinds of any onium ions. Examples of the onium ion include an ammonium ion, a phosphonium ion, a sulfonium ion, etc.

In particular, the onium ion is preferably the ammonium ion. This is because the chemical viscosity-reducing material is available easily and steadily, and it is easy for the available chemical viscosity-reducing material to reduce the viscosity of the fluid.

The metal salt is a salt that contains a metal element as a constituent element. The metal salt may be a reactant (salt) of any acid and any basic metal compound, or may be a reactant (salt) of any base and any acid metal compound.

In particular, as described above, the metal element is preferably any of the alkali metal element and the alkali-earth metal element, and therefore the metal salt is preferably any of an alkali metal salt and an alkali-earth metal salt.

Specific examples of the metal salt include a metal salt peroxide, a metal salt persulfate, a metal salt perborate, a metal salt hypochlorite, a metal salt hypobromite, a metal salt chlorite, a metal salt chlorate, a metal salt perchlorate, a metal salt bromate, a metal salt iodate, a metal salt sulfate, a metal salt percarbonate, a metal salt carbonate, a metal salt acetate, a metal salt acetyl hydroperoxide, a metal hydroxide salt, a metal salt permanganate, a metal salt molybdate, a metal salt thiosulfate, a metal salt sulfite, an ionic transition metal salt, etc.

The metal salt peroxide is, for example, a sodium peroxide, a calcium peroxide, a magnesium peroxide, etc. The metal salt persulfate is, for example, a sodium persulfate, a potassium persulfate, etc. The metal salt perborate is, for example, a sodium perborate, etc. The metal salt hypochlorite is, for example, a sodium hypochlorite, a potassium hypochlorite, etc. The metal salt hypobromite is, for example, a sodium hypobromite, etc. The metal salt chlorite is, for example, a sodium chlorite, a potassium chlorite, etc. The metal salt chlorate is, for example, a sodium chlorate, a potassium chlorate, etc. The metal salt perchlorate is, for example, a sodium perchlorate, a potassium perchlorate, etc. The metal salt bromate is, for example, a sodium bromate, a potassium bromate, etc. The metal salt iodate is, for example, a sodium iodate, a potassium iodate, a magnesium iodate, etc. The metal salt sulfate is, for example, a calcium sulfate, etc. The metal salt percarbonate is, for example, a sodium percarbonate, a potassium percarbonate, etc. The metal salt carbonate is, for example, a sodium bicarbonate, a potassium bicarbonate, etc. The metal salt acetate is, for example, a sodium acetate, a potassium acetate, etc. The metal salt acetyl hydroperoxide is, for example, a sodium acetyl hydroperoxide, potassium acetyl hydroperoxide, etc. The metal hydroxide salt is, for example, a sodium hydroxide, a potassium hydroxide, a calcium hydroxide, etc. The metal salt permanganate is, for example, a sodium permanganate, a potassium permanganate, etc. The metal salt molybdate is, for example, a sodium molybdate, a lithium molybdate, a potassium molybdate, etc. The metal salt thiosulfate is, for example, a sodium thiosulfate and a potassium thiosulfate. The metal salt sulfite is, for example, a sodium sulfite, a potassium sulfite, etc. The ionic transition metal salt is, for example, a first ferric sulfate, a second ferric sulfate, a zirconium salt, etc.

In particular, as described above, the metal salt is preferably any of the alkali metal salt and the alkali-earth metal salt, and therefore any of the sodium persulfate, the potassium persulfate, etc. is preferable.

The metal oxide is an oxide that contains a metal element as a constituent element. In particular, as described above, the metal element is preferably any of the alkali metal element and the alkali-earth metal element, and therefore the metal oxide is preferably any of the alkali metal oxide and the alkali-earth metal oxide, for example. Specific examples of the metal oxide include a calcium oxide, a barium oxide, a titanium oxide, a silicon oxide, an aluminum oxide, etc.

The non-metal oxide is an oxide that contains no metal element as a constituent element, and is, for example, a chlorine dioxide, etc.

The inorganic oxide is an inorganic-type oxide that contains no metal element as a constituent element, and is, for example, a hydrogen peroxide, etc.

The inorganic acid is an inorganic-type acid that contains no metal element as a constituent element, and is, for example, a hydrochloric acid, a sulfuric acid, a phosphoric acid, a boric acid, etc.

The inorganic acid salt is a reactant (salt) of any inorganic acid that contains no metal element as a constituent element and a basic metal compound. Specific examples of the inorganic acid salt include a zeolite, a sodium phosphate, a potassium phosphate, a potassium chloride, a sodium borate, a potassium borate, a sodium hydrogensulfate, a potassium hydrogensulfate, etc.

The organic peroxide is an organic-type peroxide that contains no metal element as a constituent element. Specific examples of the organic peroxide include a carbamide peroxide, a carbamate peroxide, an acetyl hydroperoxide, a perbenzoic acid, etc.

The organic acid is an organic-type acid that contains no metal element as a constituent element. Specific examples of the organic acid include an acetic acid, a propionic acid, a citric acid, a formic acid, a lactic acid, a butyric acid, an ascorbic acid, an erythorbic acid, an oxalic acid, a malic acid, a fumaric acid, a benzoic acid, a hydroquinone, etc.

The metal halide is a halide that contains a metal element as a constituent element. A kind of halogen is not specifically limited; however, examples of the halogen include one kind or not less than two kinds of fluorine (F), chlorine (Cl), bromine (Br), iodine (I), etc. Specific examples of the metal halide include a sodium fluoride, a potassium fluoride, a calcium fluoride, etc.

The metal sulfide is a sulfide that contains a metal element as a constituent element. Specific examples of the metal sulfide include a zinc sulfide, a molybdenum sulfide, a zirconium sulfide, etc.

The enzyme is a protein molecule in which about 150 to 500 amino acids are bound, and specific examples thereof include proteinases, peptidases, etc.

The onium salt is a salt containing an onium ion as a cation (a positive ion), and more specifically is a reactant (salt) of any acid and any basic onium compound. In particular, as described above, the onium ion is preferably an ammonium ion, and therefore the onium salt is preferably an ammonium salt.

Specific examples of the onium salt include an ammonium persulfate, an ammonium sulfate, an ammonium bicarbonate, an ammonium acetate, an ammonium molybdate, an ammonium fluoride, etc. In particular, as described above, the onium salt is preferably the ammonium salt, and therefore the ammonium persulfate, etc. are preferable.

### [Outer Part]

The outer part 2 is a so-called shell of the encapsulated agent, and covers a surface of the central part 1. The outer part 2 may employ a single-layer or multi-layer configuration.

An average thickness of the outer part 2 is not specifically limited; however, is, for example, within the range of about 40 μm to about 100 μm. The average thickness of the outer part 2 has a possibility of influencing, for example, gradual release speed, etc. of the outer part 2 to be described later.

As described above, to provide the central part 1 inside the hollow structure of the outer part 2, the outer part 2 preferably covers all of the surface of the central part 1. In other words, preferably, the central part 1 is not exposed. This is because the central part 1 (the viscosity-reducing material) is released into the fluid after the elapse of a certain period of time (a period of time necessary for gradual release of the central part 1 that is performed by the outer part 2) after the start of use of the encapsulated agent, which makes it possible to intentionally and sufficiently delay the timing when the viscosity-reducing material exercises the viscosity-reducing function substantially. The reason for this is as follows.

It is to be noted that, hereinafter, for simplicity of explanation, a period of time until the elapse of the certain period of time after the start of use of the fluid is referred to as a “former period of use”, and a period of time after the elapse of the certain period of time is referred to as a “latter period of use”.

The “former period of use” is mainly a period of time in which the viscosity-reducing material has difficulty in exercising the viscosity-reducing function substantially because the central part 1 (the viscosity-reducing material) is covered with the outer part 2, and the central part 1 is not exposed. Meanwhile, the “latter period of use” is mainly a period in which the viscosity-reducing material is able to exercise the viscosity-reducing function substantially because the central part 1 (the viscosity-reducing material) that is covered with the outer part 2 is released into the fluid due to the gradual release of the central part 1 that is performed by the outer part 2.

As described later, in a case where a fluid containing the encapsulated agent is used, it is desirable that the viscosity be not reduced immediately from the start of use of the fluid (the former period of use), but the viscosity of the fluid be reduced for the first time at the time after the elapse of the certain period of time (the latter period of use) after the start of use of the fluid. This is because, for example, in a case where the fluid containing the encapsulated agent is used in the hydrofracturing technique (the fracturing fluid), it is demanded to keep the viscosity of the fluid in an almost initial state during the former period of use, and to reduce the viscosity of the fluid substantially during the latter period of use, as described above. As a result, while using a common (one kind) fluid during each of the former period of use and the latter period of use, it is possible to make use of advantages based on the relatively-high-viscosity property of the fluid during the former period of use, and to make use of advantages based on the relatively-low-viscosity property of the fluid during the latter period of use.

In a case where not all of the surface of the central part 1 is covered with the outer part 2, part of the central part 1 is exposed from the start of use of the fluid. In such a case, the central part 1 (the viscosity-reducing material) has been already released into the fluid from the former period of use, and therefore the viscosity-reducing material exercises the viscosity-reducing function unintentionally during the former period of use. This results in reduction in the viscosity of the fluid from the former period of use, making it difficult to make use of the advantages based on the high-viscosity property of the fluid during the former period of use.

In contrast, in a case where all of the surface of the central part 1 is covered with the outer part 2, the central part 1 is not exposed at the start of use of the fluid. In such a case, the central part 1 (the viscosity-reducing material) is still less likely to be released into the fluid during the former period of use, and therefore the viscosity-reducing material is less likely to exercise the viscosity-reducing function during the former period of use. As a result, the viscosity of the fluid is kept in the almost initial state during the former period of use, making it easy to make use of the advantages based on the high-viscosity property of the fluid during the former period of use.

In addition, the outer part 2 performs the gradual release of the central part depending on a specific condition, and accordingly the central part 1 is released into the fluid. The “specific condition” refers to one kind or not less than two kinds of conditions including temperature, time, etc. The basis (principle) on which the outer part 2 performs the gradual release of the central part 2 is described later. In this case, because the central part 1 (the viscosity-reducing material) is released into the fluid at the time of the elapse of a period necessary for the gradual release of the central part 1 that is performed by the outer part 2 (the former period of use), the viscosity-reducing material exercises the viscosity-reducing function after the elapse of the period of time necessary for the gradual release of the central part 1 that is performed by the outer part 2 (the latter period of use). This results in substantial reduction in the viscosity of the fluid during the latter period of use, making it easy to make use of the advantages based on the low-viscosity property of the fluid during the latter period of use.

Accordingly, when all of the surface of the central part 1 is covered with the outer part 2, the continuous use of one kind of fluid containing the encapsulated agent makes it possible to utilize two kinds of advantages based on the mutually-conflicting viscosity properties of the fluid during the former period of use and the latter period of use.

Accordingly, the outer part 2 desirably has mainly four properties described below.

Firstly, even in a state where the encapsulated agent is contained in the fluid, the outer part 2 desirably keeps protecting the central part 1 during the former period of use. This is because protection of the central part 1 with use of the outer part 2 during the former period of use prevents the viscosity-reducing material from exercising the viscosity-reducing function unintentionally. The kind of the fluid is not specifically limited, and the fluid contains one kind or not less than two kinds of liquids including water, an organic solvent, etc. for example.

Secondly, the outer part 2 desirably performs the gradual release of the central part 1 rapidly and sufficiently after the elapse of a predetermined period of time from the start of use of the fluid containing the encapsulated agent. This is because, during the latter period of use, the central part 1 is exposed intentionally, and the viscosity-reducing material thereby exercises the viscosity-reducing function.

Thirdly, the gradual release speed, etc. of the outer part 2 are desirably readily-controlled depending on one kind or not less than two kinds of conditions including temperature, time, etc. This is because the gradual release speed, etc. of the outer part 2 is easily influenced by temperature, time, etc. Further, this is also because timing when the viscosity-reducing function of the viscosity-reducing material is exercised, that is, timing when the viscosity of the fluid is reduced is readily controlled. It is to be noted that the gradual release speed, etc. of the outer part 2 may be also possibly influenced by the configuration of the outer part 2 itself that is represented by, for example, a formation material, an average thickness, etc. in some cases.

Fourthly, desirably, the outer part 2 is unlikely to impede the viscosity-reducing function of the viscosity-reducing material after the gradual release of the central part 1. This is because the viscosity of the fluid is unlikely to be reduced sufficiently during the latter period of use when the viscosity-reducing function of the viscosity-reducing material is impeded due to the outer part 2 after the gradual release.

To secure these four properties, the outer part 2 contains a polymer compound that enables gradual release of the central part 1 in the fluid containing the encapsulated agent.

A statement describing that “the outer part 2 is able to perform gradual release of the central part 1 in the fluid” means that it is possible to gradually release the central part 1 into the fluid utilizing some kind of phenomenon in the fluid, as mentioned above. The reason for the gradual release of the central part 1 that is performed by the outer part 2 is to exercise the above-described function of the viscosity-reducing material by exposing the central part 1 after the elapse of a certain period of time to some extent after the start of use of the encapsulated agent, not from the time of the start of use of the encapsulated agent.

It is to be noted that the kind of phenomenon to be utilized for the gradual release of the central part 1 by a holding material is not limited specifically. However, for example, it includes one kind or not less than two kinds of any state variations due to any external sources. “Any external sources” refer to, for example, heat, friction, pressure, contact with a fluid (for example, water or any other fluid), etc. “Any state variations” refer to thermal expansion, melting, cracking, deformation, cleavage, swelling, dissolution, dispersion into the fluid, etc.

Specifically, the outer part 2 includes a styrene-butadiene copolymer that is a polymer compound of a water-based emulsion type as a polymer compound that enables gradual release of the central part 1 in the fluid. The glass-transition temperature of the styrene-butadiene copolymer is from −20 degrees centigrade to 80 degrees centigrade, preferably from −20 degrees centigrade to 50 degrees centigrade, and more preferably from −20 degrees centigrade to 30 degrees centigrade. In order to measure the glass-transition temperature of the styrene-butadiene copolymer, the encapsulated agent (the outer part 2) may be analyzed, for example, by a differential thermal analysis (DTA: Differential thermal analysis). This is because the styrene-butadiene copolymer whose glass-transition temperature is within the above-described ranges has the optimal glass-transition temperature in terms of the above-described four properties, and therefore it has superior properties. It is to be noted that the “styrene-butadiene copolymer” refers to a copolymer of styrene and 1, 3-butadiene, that is, so-called styrene-butadiene rubber.

The kind of the styrene-butadiene copolymer is not specifically limited as long as it has the glass-transition temperature within the above-described ranges. Specifically, the number of kinds of the styrene-butadiene copolymer may be only one, or not less than two, as long as the styrene-butadiene copolymer has the glass-transition temperature within the above-described ranges. In particular, it is preferable to use not less than two kinds of styrene-butadiene copolymers that are different from one another in the glass-transition temperature. This is because the styrene-butadiene copolymer has further superior properties in terms of the above-described four properties, which allows improved effects to be achieved.

Further, the styrene-butadiene copolymer may not be modified, or may be modified by one kind or not less than two kinds of functional groups. However, in particular, the styrene-butadiene copolymer is preferably modified. This is because the styrene-butadiene copolymer has further superior properties in terms of the above-described four properties, which allows improved effects to be achieved. It is to be noted that, in a case where the styrene-butadiene copolymer is modified, a kind of such modification is not specifically limited; however, is preferably carboxy modification. This is because further improved effects are achieved.

The styrene-butadiene copolymer has the outstandingly superior water-resistant property, in particular. Therefore, for example, in a case where the encapsulated agent is used in the hydrofracturing technique (the fracturing fluid), etc., even in a state where the encapsulated agent is included in water, the outer part 2 exhibits the superior performance in terms of the above-described first property. In other words, the outer part 2 is able to sufficiently protect the central part 1 even in water.

The content (wt %) of the outer part 2 in the encapsulated agent (the central part 1 and the outer part 2) is not specifically limited; however, is, for example, within the range of about 3 wt % to about 50 wt %. This is because, when the content of the outer part 2 is smaller than 3 wt %, the weight of the outer part 2 is excessively small relative to the weight of the central part 1, and therefore there is a possibility that the performance of covering of the central part 1 that is achieved by the outer part 2 will be insufficient. In contrast, this is because, when the content of the outer part 2 is greater than 50 wt %, the weight of the outer part 2 is excessively great relative to the weight of the central part 1, and therefore there is a possibility that the performance of gradual release of the central part 1 that is achieved by the outer part 2 will be insufficient.

### [Other Materials]

It is to be noted that the outer part 2 may further include one kind or not less than two kinds of other materials.

FIG. 2 illustrates another cross-sectional configuration of the encapsulated agent, and corresponds to FIG. 1. The other materials includes, for example, one kind or not less than two kinds of a plurality of particulate substances 3. This is because, at the time of manufacturing of the encapsulated agent (formation of the outer part 2), the granulating effect is improved, and aggregation of particles with each other in the middle of granulating is suppressed. In a case where the outer part 2 includes the plurality of particulate substances 3, the plurality of particulate substances 3 are dispersed in the above-described styrene-butadiene copolymer, and a dispersion state of the plurality of particulate substances 3 is maintained by the styrene-butadiene copolymer. It is to be noted that, in a case where the outer part 2 includes other polymer compound, etc. to be described later, the dispersion state of the plurality of particulate substances 3 is also maintained by the other polymer compound, etc.

The plurality of particulate substances 3 are so-called fillers, and contain one kind or not less than two kinds of an inorganic material, etc. for example. Examples of the inorganic material include a titanium oxide, a silicon oxide, talc, mica, clay, bentonite, an aluminum oxide, a zeolite, etc. In particular, the silicon oxide, the talc, and the bentonite are preferable, and the talc is more preferable. This is because the encapsulated agents are less likely to be aggregated with one another. The plurality of particulate substances 3 are preferably dispersed in the outer part 2, for example.

The shape of the plurality of particulate substances 3 is not specifically limited; however, includes one kind or not less than two kinds of spherical, plate-like, massive, needle-like, fibrous, indefinite shapes, etc. FIG. 2 illustrates a case where the plurality of particulate substances 3 take the spherical shapes, for example.

The average particle size (the volumetric average particle size) of the plurality of particulate substances 3 is not specifically limited; however, is preferably smaller than a thickness of the outer part 2 in terms of the granulating effect. Specifically, for example, in a case where the average thickness of the outer part 2 is within the range of about 40 μm to about 100 μm, the volumetric average particle size of the plurality of particulate substances 3 is preferably within the range of about 0.1 μm to about 20 μm as a guide.

The content of the plurality of particulate substances 3 in the outer part 2 is not specifically limited; however, is preferably not excessively great. Specifically, the content of the plurality of particulate substances 3 in the outer part 2 is, for example, within the range of about 10 wt %/o to about 40 wt %, and is preferably within the range of about 15 wt % to about 30 wt %. This is because, when the content of the plurality of particulate substances 3 is excessively great, there is a possibility that the gradual release speed, etc. of the outer part 2 will suffer adverse effect.

Further, the other materials include, for example, one kind or not less than two kinds of other polymer compounds (excluding the above-described styrene-butadiene copolymer). Examples of the other polymer compounds include polyurethane, polyester, polyacrylate, polyvinyl alcohol, polystyrene, polybutadiene, cellulose, gelatin, isocyanate adduct of polyol, vinylidene chloride-methyl acrylate copolymer, etc. Besides the above, the other materials may be also, for example, wax, dry oil, etc.

In addition, the other materials may be a variety of additive agents, for example. Such an additive agent is, for example, a film-forming auxiliary agent that fixes up resin-film formation. Alternatively, the additive agent is an anti-blocking agent having a function of suppressing aggregation of the encapsulated agents with each other (an anti-blocking function).

### [1-2. Function]

The encapsulated agent functions as follows by being used in a state of being included in the fluid.

During the former period of use, the central part 1 (the viscosity-reducing material) is covered with the outer part 2. In such a case, because the viscosity-reducing material is not released into the fluid, the viscosity-reducing material is still unable to exercise the viscosity-reducing function. As a result, the viscosity of the fluid is maintained in an almost initial state (a state at the time of start of use of the fluid).

During the latter period of use, when the outer part 2 performs gradual release of the central part 1, the central part 1 (the viscosity-reducing material) is released into the fluid. As a result, the viscosity-reducing material exercises the viscosity-reducing function, leading to reduction in the viscosity of the fluid.

It is to be noted that a sustained period of time of the former period of use, that is, the period during which the viscosity of the fluid is maintained in the almost initial state is determined, for example, depending on one kind or not less than two kinds of conditions including duration of use of the fluid, temperature, etc., as described above. This is because these conditions affect the gradual release speed, etc. of the outer part 2 in the fluid.

For example, in a case where the outer part 2 dissolves over time in the fluid, it is difficult for the outer part 2 to dissolve sufficiently when the duration of use of the fluid is short, but it is easy for the outer part 2 to dissolve sufficiently when the duration of use of the fluid is long. Further, for example, in a case where the dissolution property of the outer part 2 varies depending on the temperature of the fluid, for example, it is difficult for the outer part 2 to dissolve sufficiently when the temperature of the fluid is low, but it is easy for the outer part 2 to dissolve sufficiently when the temperature of the fluid becomes high.

### [1-3. Manufacturing Method]

The above-described encapsulated agent is manufactured by the following procedures, for example.

It is to be noted that the configuration of the encapsulated agent (formation materials of a series of the component parts) has been described in detail already, and therefore the relevant descriptions are hereinafter omitted as appropriate.

First, the central part 1 containing the viscosity-reducing material, and a coating solution to be used for formation of the outer part 2 are prepared.

In preparing the coating solution, for example, a latex of the styrene-butadiene copolymer and a solvent are mixed, and thereafter the mixture is stirred. The styrene-butadiene copolymer is thereby dissolved by the solvent, leading to obtainment of the coating solution. The kind of the solvent is not specifically limited; however, includes one kind or not less than two kinds of water, alcohol, etc., for example. It is to be noted that the content of the styrene-butadiene copolymer in the coating solution may be set to any content.

Next, the coating solution is supplied to the surface of the central part 1, and thereafter, the coating solution is dried. As a result, the outer part 2 containing the styrene-butadiene copolymer is formed in such a manner that the surface of the central part 1 is coated with the outer part 2. In this case, a process of forming the outer part 2 may be repeated twice or more. It is to be noted that, in a case where the outer part 2 containing the plurality of particulate substances 3 is formed, for example, the plurality of particulate substances 3 may be put into the coating solution in the course of supply of the coating solution. In such a case, the plurality of particulate substances 3 may be put in at a time, or the plurality of particulate substances 3 may be put in a plurality of times separately.

Such a method of forming the outer part 2 is not limited specifically. Specifically, a method of supplying the coating solution includes, for example, one kind or not less than two kinds of a coating method, a spray method, etc., for example.

Further, equipment to be used for the formation of the outer part 2 is not limited specifically. Specifically, the equipment includes, for example, one kind or not less than two kinds of a high-speed mixer, a spray dry, fluidized-bed granulation coating equipment, etc. In particular, the fluidized-bed granulation coating equipment is preferably rolling-motion fluidized-bed coating equipment, swing-motion fluidized-bed coating equipment, Wurster-type fluidized-bed granulation coating equipment, etc. For example, the rolling-motion fluidized-bed granulation coating equipment is equipment that applies the coating solution onto the surface of the central part 1 with use of a spray nozzle while fluidizing the central part 1 being coated spirally on a rotating plate in the inside of a cylindrical rolling-motion fluidized-bed. In this case, wind flows from a lower part to an upper part in the inside of the rolling-motion fluidized-bed, and the central part 1 is thereby rolled upward, which gives a longitudinal motion to the central part 1. In addition, the central part 1 is rotated by rotation of the rotating plate, which gives a horizontal motion to the central part 1. Thereby, the central part 1 is fluidized spirally.

The following advantages are obtained by utilizing the coating principle of the fluidized-bed granulation coating equipment. Firstly, the surface of the central part 1 is coated evenly, which ensures that the outer part 2 is formed in such a manner that a uniform thickness is achieved. Secondly, the coating amount is adjusted easily and accurately, and therefore a thickness of the outer part 2 is strictly controlled. Thirdly, in accordance with the strict control of the thickness of the outer part 2, dimensions (average particle size, etc.) of the encapsulated agent are also controlled strictly.

Hence, the viscosity-reducing material (the central part 1) is provided inside the hollow structure (the outer part 2), bringing the encapsulated agent to completion.

### [1-4. Workings and Effects]

According to the encapsulated agent of the embodiment of the invention, the surface of the central part 1 containing the viscosity-reducing material is covered with the outer part 2 containing the styrene-butadiene copolymer whose glass-transition temperature is within the appropriate range described above.

In this case, as described above, when the fluid containing the encapsulated agent is used, the central part 1 is covered with the outer part 2 during the former period of use, and therefore the viscosity-reducing material has still difficulty in exercising the viscosity-reducing function. As a result, the viscosity of the fluid is kept in the initial state, leading to utilization of the advantages based on the high-viscosity property of the fluid. Meanwhile, during the latter period of use, because the viscosity-reducing material is released into the fluid owing to gradual release of the central part 1 that is performed by the outer part 2, the viscosity-reducing material exercises the viscosity-reducing function. As a result, the viscosity of the fluid is reduced, leading to utilization of the advantages based on the low-viscosity property of the fluid.

In addition, because the glass-transition temperature of the styrene-butadiene copolymer contained in the outer part 2 is made appropriate in terms of the above-described four properties that are demanded for the outer part 2, the styrene-butadiene copolymer has superior property than other polymer compounds. An example of such “other polymer compounds” is a styrene-butadiene copolymer that has no glass-transition temperature within the appropriate range described above. Further, the “other polymer compounds” are polymer compounds other than the styrene-butadiene copolymer, and are, for example, polystyrene, polybutadiene, etc. Accordingly, a period of time in which the viscosity of the fluid is maintained (the former period of use of the fluid) is ensured sufficiently, and such a period of time is controlled easily. Further, during a period of time after the elapse of the above-described period of time (the latter period of use of the fluid), the viscosity of the fluid is reduced sufficiently in a short time.

Therefore, in using the fluid containing the encapsulated agent, the viscosity of the fluid is reduced sufficiently in a short time at desired timing while using one kind of fluid. Accordingly, it is possible to exercise the superior viscosity-reducing function with respect to the fluid to be used for the application demanding reduction in the viscosity in the middle of use.

In particular, in the encapsulated agent according to the embodiment of the invention, when the styrene-butadiene copolymer whose glass-transition temperature is within the appropriate range described above is carboxy-modified, the styrene-butadiene copolymer has a further superior property in terms of the above-described four properties, which allows the improved effects to be obtained.

Further, in a case where the fluid is used in the hydrofracturing technique, and the fluid contains the viscosity-thickening agent, when the central part 1 includes a material that decomposes the viscosity-thickening agent, the viscosity-thickening agent is decomposed in the middle of use of the fluid, resulting in reduction in the viscosity of the fluid. Consequently, for a reason similar to that in the above-described case where the central part 1 includes the viscosity-reducing material, it is possible to exercise the superior viscosity-reducing function.

When the outer part 2 contains the plurality of particulate substances 3, the granulation effect is improved and aggregation of particles with each other in the course of granulation is suppressed at the time of manufacturing of the encapsulated agent (formation of the outer part 2), leading to the improved dispersion property of the encapsulated agent in the fluid. This allows the improved effects to be obtained.

### [2. Application of Encapsulated Agent (Variable Viscosity Fluid)]

Next, a description is provided of an application of the above-described encapsulated agent.

As described above, the application of the encapsulated agent is not specifically limited as long as such an application demands reduction in the viscosity of the fluid containing the encapsulated agent in the middle of use of the fluid.

Here, a fluid whose viscosity is reduced by utilizing the encapsulated agent is referred to as a “variable viscosity fluid”. The “variable viscosity fluid” is a fluid having viscosity that is able to sufficiently reduce the viscosity in the middle of use thereof to achieve a specific objective.

To “sufficiently reduce the viscosity” means that the viscosity is sufficiently reduced to the degree that allows the advantages based on the relatively-high viscosity of the fluid (advantages derived from high viscosity) to be utilized during the former period of use (before reduction in the viscosity of the fluid), as well as to the degree that allows the advantages based on the relatively-low viscosity of the fluid (advantages derived from low viscosity) to be utilized during the latter period of use (after reduction in the viscosity of the fluid). As a result, during the course from the former period of use until the latter period of use, this makes it possible to utilize two kinds of advantages based on the mutually-conflicting viscosity properties of the fluid, that is, the advantages derived from high viscosity and the advantages derived from low viscosity while continuously using a common (one kind) fluid.

### [2-1. Configuration]

FIG. 3 illustrates a configuration of the variable viscosity fluid according to an embodiment of the invention. The variable viscosity fluid includes a fluid body 11, and one or not less than two encapsulated agents 12.

### [Fluid Body]

The fluid body 11 is a main component of the variable viscosity fluid, and the encapsulated agent 12 and other materials to be described later are dispersed or dissolved in the fluid 11 body. An example of the fluid body 11 includes a liquid. This is because the encapsulated agent 12 is easily dispersed in the fluid body 11, and a dispersion state of the encapsulated agent 12 is easily maintained. The liquid contains, for example, one kind or not less than two kinds of water, an organic solvent, etc. It is to be noted that, for example, in a case where the variable viscosity fluid is used in the hydrofracturing technique (the fracturing fluid), the above-described liquid contains water.

### [Encapsulated Agent]

The encapsulated agent 12 has a configuration similar to that of the above-described encapsulated agent according to the embodiment of the invention. In other words, the encapsulated agent 12 includes the central part 1 containing the viscosity-reducing material, and the outer part 2 containing the styrene-butadiene copolymer whose glass-transition temperature is within the appropriate range, as illustrated in FIG. 1.

For example, in a case where the variable viscosity fluid is used in the hydrofracturing technique (the fracturing fluid), the encapsulated agent 12 that serves as the viscosity-reducing agent is called a breaker. It is to be noted that the viscosity-reducing material that exercises the viscosity-reducing function essentially in the encapsulated agent 12 may be called the breaker in some cases.

Preferably, the encapsulated agent 12 is dispersed in the fluid body 11. This is because the viscosity of the variable viscosity fluid is easily reduced evenly. It is to be noted that the content of the encapsulated agent 12 in the fluid body 11 is not limited specifically. It is possible to set the content of the encapsulated agent 12 to any content depending on conditions such as the viscosity of the variable viscosity fluid during the latter period of use, for example.

### [Other Materials]

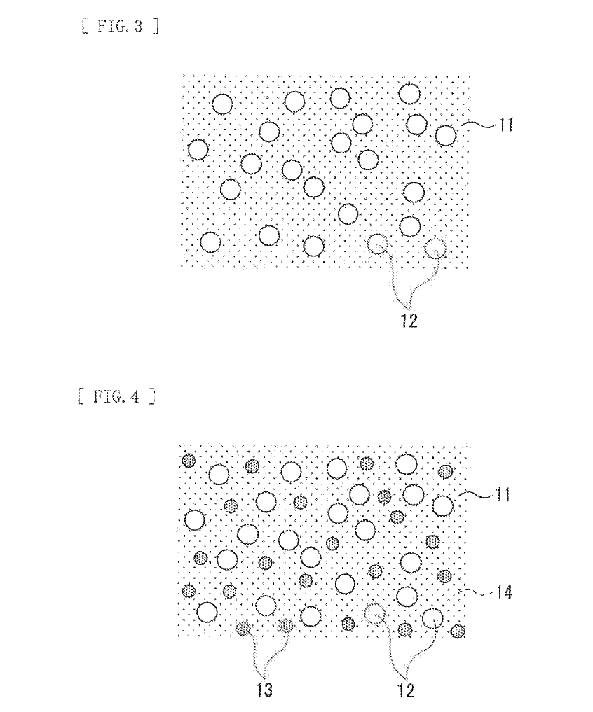

It is to be noted that the variable viscosity fluid may further include one kind or not less than two kinds of other materials. FIG. 4 illustrates another configuration of the variable viscosity fluid, and corresponds to FIG. 3.

### [Plurality of Particulate Substances]

The other materials are, for example, one kind or not less than two kinds of any of a plurality of particulate substances 13 (a plurality of second particulate substances). The plurality of particulate substances 13 to be described here are based on a concept that is different from the concept intended for the plurality of particulate substances 3 (a plurality of first particulate substances) described above. In other words, for example, as described below, the plurality of particulate substances 13 serve as proppants, unlike the plurality of particulate substances 3 that serve as fillers. More specifically, the plurality of particulate substances 3 are held by the styrene-butadiene copolymer in the outer part 2. In contrast, the plurality of particulate substances 13 are not held by the styrene-butadiene copolymer in the outer part 2, but are dispersed in the fluid body 11.

The plurality of particulate substances 13 contain, for example, one kind or not less than two kinds of sand, etc., and the sand, etc. may be covered with one kind or not less than two kinds of polymer compounds. The kind of the sand is not specifically limited as long as it is a rock fragment, a mineral fragment, etc. The kind of the polymer compound is not specifically limited as long as it is possible to sufficiently cover surfaces of the sand, etc. The number of kinds of the polymer compound may be only one or not less than two.

Preferably, the plurality of particulate substances 13 are dispersed in the fluid body 11. This is because the plurality of particulate substances 13 fulfill their primary roles more easily as compared with a case where the plurality of particulate substances 13 remain in a state of aggregation and sedimentation, etc.

It is to be noted that the content of the plurality of particulate substances 13 in the fluid body 11 is not specifically limited; however, is determined depending on, for example, a role (a function), an application, a purpose, etc. of the variable viscosity fluid. Further, the role of the plurality of particulate substances 13 is not specifically limited; however, is determined depending on, for example, the application, the purpose, etc. of the variable viscosity fluid, as with the case of the content as described above.

For example, in a case where the variable viscosity fluid is used in the hydrofracturing technique (the fracturing fluid), the plurality of particulate substances 13 serve as the so-called proppants. As described above, the proppant is used to prevent cracks arising in destroying a reservoir from being blocked. In this case, it is preferable that the plurality of particulate substances 13 be dispersed in the fluid body 11, and that such a dispersion state of the plurality of particulate substances 13 be maintained. This is because the transport property of the plurality of particulate substances 13 is improved during use of the variable viscosity fluid. As a result, when the variable viscosity fluid comes into the cracks, the plurality of particulate substances 13 are more likely to come into the cracks along with the fluid body 11. Further, the amount of the plurality of particulate substances 13 that come into each of the cracks is less likely to vary.

It is to be noted that the plurality of particulate substances 13 are not limited to the proppant. In a case where the variable viscosity fluid is used for any application other than the hydrofracturing technique (the fracturing fluid), the plurality of particulate substances 13 may be used for a purpose that is different from the proppant.

### [Viscosity-Thickening Agent]

Further, the other materials are, for example, one kind or not less than two kinds of a viscosity-thickening agent 14. The viscosity-thickening agent 14 serves to increase the viscosity of the variable viscosity fluid during the former period of use, and contains, for example, one kind or not less than two kinds of a gelling agent, a cross-linking agent, etc. The gelling agent contains, for example, one kind or not less than two kinds of guar gum, carboxymethyl cellulose, etc. The cross-linking agent contains, for example, one kind or not less than two kinds of a boric acid, a zirconium complex, etc. In a case where the variable viscosity fluid contains the gelling agent, for example, the variable viscosity fluid is gelated. It is to be noted that the content of the viscosity-thickening agent 14 in the fluid body 11 is not limited specifically. It is possible to set the content of the viscosity-thickening agent 14 to any content depending on conditions such as the viscosity of the variable viscosity fluid during the former period of use, for example. The viscosity-thickening agent may be either dissolved or dispersed in the fluid body 11, or may be both dissolved and dispersed in the fluid body 11.

In a case where the variable viscosity fluid does not contain the viscosity-thickening agent 14, the viscosity of the variable viscosity fluid during the former period of use is determined substantially on the basis of the viscosity of the fluid body 11 itself. In this case, it is preferable that the viscosity of the variable viscosity fluid during the former period of use be sufficiently high to maintain a dispersion state of the encapsulated agent 12, etc. in the fluid body 11. Therefore, in a case where the viscosity of the variable viscosity fluid during the former period of use is not sufficiently high, the viscosity of the variable viscosity fluid during the former period of use is preferably increased with use of the viscosity-thickening agent 14. This is because aggregation, sedimentation, etc. of the encapsulated agent 12, etc. are less likely to occur in the fluid body 11, and thus the dispersion state of the encapsulated agent 12, etc. is more likely to be maintained in the fluid body 11.

### [Additive Agent]

Further, the other materials are one kind or not less than two kinds of a variety of additive agents. Examples of the additive agent include a friction-reducing agent, a surfactant agent, a pH adjuster, a corrosion inhibitor, a biocide, an iron-control agent, etc.

The friction-reducing agent mainly controls the fluidity of the plurality of particulate substances 13 in the variable viscosity fluid. The friction-reducing agent contains, for example, one kind or not less than two kinds of polyacrylamide, etc.

The surfactant agent mainly controls the dispersibility, fluidity, etc. of the viscosity-reducing material. The surfactant agent contains, for example, one kind or not less than two kinds of an alcohol-based active agent, etc.

The pH adjuster mainly adjusts pH of the variable viscosity fluid. The pH adjuster contains, for example, one kind or not less than two kinds of a potassium carbonate, etc.

The corrosion inhibitor mainly prevents corrosion of a device, an instrument, etc. that are brought into contact with the variable viscosity fluid during use of the variable viscosity fluid. The corrosion inhibitor contains, for example, one kind or not less than two kinds of formaldehyde, isopropyl alcohol, etc. It is to be noted that the device, the instrument, etc. that come in contact with the variable viscosity fluid are, for example, a pipe, etc. to be used for transportation of the variable viscosity fluid.

The biocide mainly suppresses an increase in the amount of microorganisms mixed into the variable viscosity fluid. The biocide contains, for example, one kind or not less than two kinds of gultaraldehyde, hydrogen peroxide water, etc.

The iron-control agent mainly prevents sedimentation of a metal oxide that is attributable to iron. The iron-control agent contains, for example, one kind or not less than two kinds of an acetic acid, a citric acid, an ascorbic acid, an ethylene glycol, etc.

### [2-2. Function]

The variable viscosity fluid includes the encapsulated agent 12 having a configuration similar to that of the above-described encapsulated agent according to the embodiment of the invention. Therefore, in the course of use of the variable viscosity fluid, the viscosity of the variable viscosity fluid is reduced utilizing the encapsulated agent 13.

Specifically, during the former period of use, the viscosity-reducing material has still difficulty in exercising the viscosity-reducing function, and thus the viscosity of the variable viscosity fluid is maintained in an initial state. Meanwhile, during the latter period of use, the viscosity-reducing material exercises the viscosity-reducing function, resulting in a reduction in the viscosity of the variable viscosity fluid.

### [2-3. Workings and Effects]

According to the variable viscosity fluid of the embodiment of the invention, the variable viscosity fluid includes the one or not less than two encapsulated agents 12, and the encapsulated agent 12 has a configuration similar to that of the above-described encapsulated agent according to the embodiment of the invention. In this case, as described above, the encapsulated agent 12 exercises the superior viscosity-reducing function in the course of use of the variable viscosity fluid although the one kind of variable viscosity fluid is used, and therefore the viscosity of the variable viscosity fluid is sufficiently reduced in a short time. This allows the superior viscosity variation characteristics to be achieved with the use of the viscosity-reducing function of the encapsulated agent 12.

Because the variable viscosity fluid is particularly used in the hydrofracturing technique (the fracturing fluid), the following effects are obtained in a case where the variable viscosity fluid contains the plurality of particulate substances 13.

Firstly, during the former period of use, the viscosity of the variable viscosity fluid is maintained in the initial state, and thus the dispersion state of the plurality of particulate substances 13 is maintained in the variable viscosity fluid. Therefore, by applying pressure to the variable viscosity fluid, it is possible to make the plurality of particulate substances 13 sufficiently come into the cracks arising in destroying the reservoir utilizing the relatively-high viscosity of the variable viscosity fluid.

Secondly, during the latter period of use, the viscosity of the variable viscosity fluid is sufficiently reduced, resulting in the improved fluidity of the variable viscosity fluid. Therefore, by performing suction, etc. of the variable viscosity fluid, it is possible to collect the used variable viscosity fluid in a short time utilizing the relatively-low viscosity of the variable viscosity fluid.

Thirdly, only the common (one kind of) variable viscosity fluid has to be used to make the plurality of particulate substances 13 sufficiently come into the cracks during the former period of use, and to collect the used variable viscosity fluid in a short time during the latter period of use, as described above. This makes it possible to easily and stably utilize two kinds of advantages based on the mutually-conflicting viscosity properties of the fluid.

Any other workings and effects concerning the variable viscosity fluid are similar to the workings and effects of the encapsulated agent according to the embodiment of the invention.

### WORKING EXAMPLES

Hereinafter, a description is provided of working examples of the invention. The order of descriptions is as follows. However, the embodiments of the invention are not limited to the embodiments to be described here.

### 1. Manufacturing of Encapsulated Agent

### 2. Evaluation of Encapsulated Agent

2-1. Evaluation of Manufacturing

2-2. Evaluation of Performance

### 1. Manufacturing of Encapsulated Agent

### Experimental Examples 1 to 18

First, the encapsulated agent was manufactured by the following procedures.

In the first place, a water-based emulsion solution containing a series of the following polymer compounds was prepared. In this case, the water-based emulsion solution (concentration of solid content: 8 wt %) was prepared by diluting the water-based emulsion solution with the use of ethanol.

Experimental examples 1 to 3: carboxy-modified styrene-butadiene copolymer NALSTAR SR-100 (Tg: 27 degrees centigrade) available from NIPPON A&L INC.

Experimental examples 4 to 7 and 11 to 13: carboxy-modified styrene-butadiene copolymer NALSTAR SR-107 (Tg: −15 degrees centigrade) available from NIPPON A&L INC.

Experimental example 8: non-modified styrene-butadiene copolymer NALSTAR SR-130 (Tg: −1 degree centigrade) available from NIPPON A&L INC.

Experimental example 9: carboxy-modified styrene-butadiene copolymer NALSTAR SR-115 (Tg: 37 degrees centigrade) available from NIPPON A&L INC.

Experimental example 10: carboxy-modified styrene-butadiene copolymer NALSTAR XG-4087 (Tg: 45 degrees centigrade) available from NIPPON A&L INC.

Experimental example 14: mixture of carboxy-modified styrene-butadiene copolymer NALSTAR SR-107 (Tg: −15 degrees centigrade) available from NIPPON A&L INC. and carboxy-modified styrene-butadiene copolymer NALSTAR SR-100 (Tg: 27 degrees centigrade) available from NIPPON A&L INC. (mixing ratio: 1:1 in weight ratio) Experimental examples 15 and 16: mixture of carboxy-modified styrene-butadiene copolymer NALSTAR SR-107 (Tg: −15 degrees centigrade) available from NIPPON A&L INC. and carboxy-modified styrene-butadiene copolymer NALSTAR SR-115 (Tg: 37 degrees centigrade) available from NIPPON A&L INC. (mixing ratio: 1:1 in weight ratio)

Experimental example 17: acrylic resin Mowinyl 727 (Tg: 5 degrees centigrade) available from The Nippon Synthetic Chemical Industry Co., Ltd.

Experimental example 18: styrene-acrylic copolymer Mowinyl 749E (Tg: 25 degrees centigrade) available from The Nippon Synthetic Chemical Industry Co., Ltd.

Next, the outer part 2 was formed by coating the surface of the central part 1 with the water-based emulsion solution using the rolling-motion fluidized-bed coating equipment (type LABO available from Freund Corporation), and thereafter drying the water-based emulsion solution. As the central part 1, a potassium peroxide acting as the metal salt (volumetric average particle size: 330 μm) and an ammonium persulfate acting as the onium salt (volumetric average particle size: 430 μm) were used.

In forming the outer part 2, the water-based emulsion solution (concentration of solid content: 8 wt %) in which the plurality of particulate substances 3 were not dispersed was applied until the content (wt %) of the outer part 2 in the entirety (the central part 1 and the outer part 2) reached the amount equivalent to 80% of the predetermined content indicated in Table 1. Thereafter, the water-based emulsion solution (concentration of solid content: 8 wt %, and dispersion concentration of the plurality of particulate substances 3: 2 wt %) in which the plurality of particulate substances 3 were dispersed was applied until the content (wt %) of the outer part 2 in the entirety reached the amount equivalent to 20% of the predetermined content indicated in Table 1.

As the plurality of particulate substances 3, talc (volumetric average particle size: 4 μm), bentonite (volumetric average particle size: 550 μm), titanium oxide (volumetric average particle size: 5 μm), and a silicon oxide (volumetric average particle size: 10 μm) were used.

Finally, the central part 1 formed with the outer part 2 thereof was sorted out using a 1 mm sieve. As a result, the outer part 2 containing the polymer compound and the plurality of particulate substances 3 was formed in such a manner that a surface of the central part 1 was covered with the outer part 2, bringing the encapsulated agent to completion. A configuration of the encapsulated agent manufactured here is as indicated in Table 1.

TABLE 1

| | Central part | | Outer part | | | | | | | |
|---|---|---|---|---|---|---|---|---|---|---|
| Experimental | Viscosity-reducing | Content | Polymer | Tg | Particulate | Content | Covering | Water-resistant | Viscosity-reducing effect | |
| examples | material | (wt %) | compound | (° C.) | substance | (wt %) | property | property | 80° C. | 100° C. |
| 1 | APS | 70 | SBR | 27 | Talc | 30 | Achieved | Good | B | C |
| 2 | APS | 50 | SBR | 27 | Talc | 50 | Achieved | Good | A | B |
| 3 | KPS | 80 | SBR | 27 | Talc | 20 | Achieved | Good | A | B |
| 4 | APS | 70 | SBR | −15 | Talc | 30 | Achieved | Good | B | C |
| 5 | APS | 60 | SBR | −15 | Talc | 40 | Achieved | Good | A | B |
| 6 | KPS | 80 | SBR | −15 | Talc | 20 | Achieved | Good | A | B |
| 7 | KPS | 70 | SBR | −15 | Talc | 30 | Achieved | Good | A | B |
| 8 | APS | 70 | SBR | −1 | Talc | 30 | Achieved | Good | A | B |
| 9 | APS | 70 | SBR | 37 | Talc | 30 | Achieved | Good | A | B |
| 10 | APS | 70 | SBR | 45 | Talc | 30 | Achieved | Good | C | C |
| 11 | KPS | 70 | SBR | −15 | Bentonite | 30 | Achieved | Good | A | B |
| 12 | KPS | 70 | SBR | −15 | Titanium | 30 | Achieved | Good | A | B |
| | | | | | oxide | | | | | |
| 13 | KPS | 70 | SBR | −15 | Silicon | 30 | Achieved | Good | A | B |
| | | | | | oxide | | | | | |
| 14 | KPS | 70 | SBR | −15/27 | Talc | 30 | Achieved | Good | B | C |
| | | | (mixture) | | | | | | | |
| 15 | KPS | 70 | SBR | −15/37 | Talc | 30 | Achieved | Good | B | B |
| | | | (mixture) | | | | | | | |
| 16 | APS | 70 | SBR | −15/37 | Talc | 30 | Achieved | Good | A | B |
| | | | (mixture) | | | | | | | |
| 17 | APS | 70 | AC | 5 | Talc | 30 | Unachieved | — | — | — |
| 18 | APS | 70 | STAC | 25 | Talc | 30 | Unachieved | — | — | — |

APS: ammonium persulfate,
KPS: potassium persulfate,
SBR: styrene-butadiene rubber copolymer,
AC: acrylic resin,
STAC: styrene-acrylic copolymer

### 2. Evaluation of Encapsulated Agent

As described below, the encapsulated agent was evaluated from the viewpoint of both aspects of manufacturing and performance.

### [2-1. Evaluation of Manufacturing]

The covering property and water-resistant property of the encapsulated agent were examined to evaluate the encapsulated agent from the viewpoint of the manufacturing aspect, and a result indicated in Table 1 was obtained.

In examining the covering property, a state of the encapsulated agent was evaluated by examining whether or not the encapsulated agent was encapsulated properly, that is, whether or not the central part 1 was sufficiently covered with the outer part 2, using a digital microscope (DIGITAL MICROSCOPE KH-1300 available from HIROX Co., Ltd.). In this case, a case where the central part 1 was not exposed because the central part 1 was fully covered with the outer part 2 was determined as “achieved”. In contrast, a case where part of the central part 1 was exposed because the central part 1 was not fully covered with the outer part 2 was determined as “unachieved”.

In examining the water-resistant property, in the first place, the encapsulated agent was put into warm water of 200 cm³ (=200 ml, temperature: 60 degrees centigrade) while stirring the warm water at low speed. In this case, the input amount of the encapsulated agent was adjusted to ensure that the weight of the central part 1 was equivalent to two grams. Next, the warm water containing the encapsulated agent therein was stirred (stirring length of time: one hour), and thereafter the electrical conductivity of the warm water was measured using an electrical conductivity meter (the ECTester 11+ available from Eutech Instruments). Subsequently, the elution amount of the viscosity-reducing material was determined from a measured value of the electrical conductivity with use of a calibration curve indicating correlation between the elution amount of the central part 1 (potassium persulfate and ammonium persulfate to be used as the viscosity-reducing material) and the electrical conductivity of the warm water. Finally, the state of the encapsulated agent was evaluated on the basis of the elution amount of the viscosity-reducing material. In this case, a case where the elution amount of the viscosity-reducing material was less than 10% was determined as “good”. In contrast, a case where the elution amount of the viscosity-reducing material was 10% or more was determined as “poor”.

As indicated in Table 1, the covering property and the water-resistant property varied greatly depending on the configuration of the encapsulated agent.

More specifically, in a case where the compounds other than the styrene-butadiene copolymer were used as the formation materials (polymer compounds) of the outer part 2 (the experimental examples 17 and 18), the surface of the central part 1 was not fully covered with the outer part 2, which made it difficult to form the capsule structure fundamentally.

In contrast, in a case where the styrene-butadiene copolymer was used as the formation material of the outer part 2 (the experimental examples 1 to 16), a great difference was made in the covering property and the water-resistant property depending on glass-transition temperature of the styrene-butadiene copolymer.

Specifically, in a case where the glass-transition temperature was within the appropriate range (−20 degrees centigrade to +80 degrees centigrade) (the experimental examples 1 to 16), the surface of the central part 1 was fully covered with the outer part 2, which made it possible to form the capsule structure. In addition, the outer part 2 was not dissolved over a long period of time, which made it possible to sufficiently protect the central part 1 using the outer part 2.

### [2-2. Evaluation of Performance]

The viscosity-reducing function (the viscosity-reducing effect) of the encapsulated agent was examined to evaluate the encapsulated agent from the viewpoint of the performance aspect, and a result indicated in Table 1 was obtained. Here, to evaluate the viscosity-reducing effect of the encapsulated agent in a simplified manner, variations in the viscosity of a guar solution containing the encapsulated agent were examined.

In examining the variations in the viscosity of the guar solution, in the first place, guar powder (available from SIGMA) was dissolved in ion-exchange water of 1300 grams that was put in a beaker by adding the guar powder of 12.56 grams by a small amount at a time while stirring the ion-exchange water with use of a three-one motor. Because the guar powder was less likely to be dissolved, in a case where a mass of the undissolved guar powder was present in the ion-exchange water, the mass of the undissolved guar powder was dissolved by crushing the mass of the guar powder using a spatula. In such a manner, the guar powder was dissolved, and therefore the guar solution was obtained. Next, a cross-linking agent (boric acid) of 0.985 grams was added to the guar solution, and thereafter the guar solution was stirred (stirring length of time: four hours or longer). Subsequently, the guar solution of 160 grams was collected in a poly bottle.

Next, the guar solution was preheated (heating temperature: 80 degrees centigrade, and heating length of time: 30 minutes), and thereafter the guar solution was left as it was (duration of being left: 30 minutes). Subsequently, the viscosity (mPa·s) of the guar solution was measured using a viscosity measuring instrument (a cone-plate viscometer TVE-22H available from Toki Sangyo Co., Ltd.). In this case, a measuring range was H, rotating speed was 2.5 rpm, and temperature was 25 degrees centigrade. Subsequently, the encapsulated agent was put into the guar solution, and thereafter the guar solution was stirred. Further, the input amount of the encapsulated agent was adjusted to ensure that the weight of the central part 1 was equivalent to 0.05 grams.

Subsequently, the viscosity (mPa·s) of the guar solution was measured by taking out part of the guar solution every 30 minutes after the guar solution was stored in a thermostatic oven (the mini-jet oven MO-921 available from TOYAMA SANGYO CO., LTD., temperature: 80 degrees centigrade or 100 degrees centigrade). In this case, the measurement of the viscosity was repeated until storage time of the guar solution reached 360 hours.

Finally, the viscosity-reducing effect of the encapsulated agent was evaluated on the basis of the measurement results of the viscosity of the guar solution. In this case, a case where a reduction rate of the viscosity relative to an initial value (the viscosity at the start of storage of the guar solution) was 10% or less even after the elapse of four hours from the start of storage of the guar solution was determined as “A”. A case where the reduction rate of the viscosity relative to the initial value reached 10% or less after the elapse of two hours and before the elapse of four hours from the start of storage of the guar solution was determined as “B”. A case where the reduction rate of the viscosity relative to the initial value reached 10% before the elapse of two hours from the start of storage of the guar solution was determined as “C”.

As indicated in Table 1, in a case where the styrene-butadiene copolymer whose glass-transition temperature was within the appropriate range was used as the formation material (polymer compound) of the outer part 2 (the experimental examples 1 to 16), the viscosity-reducing effect of the encapsulated agent was exercised after the elapse of a sufficient period of time from the start of storage of the guar solution.

However, a period of time until the viscosity-reducing effect was exercised (the former period of use), and a reduction speed, etc. of the viscosity of the guar solution during a period in which the viscosity-reducing effect was exercised (the latter period of use) varied slightly depending on the configuration of the encapsulated agent.

On the basis of these results, in the encapsulated agent in which the surface of the central part 1 containing the viscosity-reducing material was covered with the outer part 2 containing the styrene-butadiene copolymer whose glass-transition temperature was within the appropriate range (−20 degrees centigrade to +80 degrees centigrade), the superior viscosity-reducing function was exercised.

The invention is described thus far with reference to the embodiments and the working examples; however, the invention is not limited to the aspects described in the embodiments and the working examples; however, various modifications may be made.

Specifically, the application of the encapsulated agent and the variable viscosity fluid is not limited to the hydrofracturing technique (the fracturing fluid), and they may be used for any application other than the hydrofracturing application. Also in such a case, the viscosity is sufficiently reduced in a short time in the course of use of the variable viscosity fluid containing the encapsulated agent, which makes it possible to achieve a variety of effects depending on the application.

This application claims the priority on the basis of Japanese Patent Application No. 2015-152589 filed on Jul. 31, 2015 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. An encapsulated agent comprising:
a central part containing a viscosity-reducing material that reduces viscosity of a fluid to be used in a hydrofracturing technique; and
an outer part that (1) covers a surface of the central part, (2) enables gradual release of the central part in the fluid, and (3) contains a styrene-butadiene copolymer having glass-transition temperature that is equal to or higher than −20 degrees centigrade and equal to or lower than 80 degrees centigrade.

2. The encapsulated agent according to claim 1, wherein the styrene-butadiene copolymer is carboxy-modified.

3. The encapsulated agent according to claim 1, wherein the outer part further includes a plurality of particulate substances held by the styrene-butadiene copolymer.

4. The encapsulated agent according to claim 1, wherein
the fluid contains a viscosity-thickening agent, and
the viscosity-reducing material contains a material that decomposes the viscosity-thickening agent.

5. A variable viscosity fluid comprising:
a fluid body; and
one or not less than two encapsulated agents including: a central part containing a viscosity-reducing material that reduces viscosity; and an outer part that (1) covers a surface of the central part, (2) enables gradual release of the central part in the fluid, and (3) contains a styrene-butadiene copolymer having glass-transition temperature that is equal to or higher than −20 degrees centigrade and equal to or lower than 80 degrees centigrade.

6. The variable viscosity fluid according to claim 5, wherein the outer part further includes a plurality of first particulate substances held by the styrene-butadiene copolymer.

7. The variable viscosity fluid according to claim 5, further comprising a plurality of second particulate substances that are not held by the styrene-butadiene copolymer.

8. The variable viscosity fluid according to claim 5, further comprising a viscosity-thickening agent, wherein
the viscosity-reducing agent contains a material that decomposes the viscosity-thickening agent.

9. The variable viscosity fluid according to claim 5, wherein the variable viscosity fluid is to be used in a hydrofracturing technique.
